(19) United States
(12) Patent Application Publication
(10) Pub. No.: US 2014/0047961 A1
(43) Pub. Date: Feb. 20, 2014

(54) SYSTEM AND METHOD TO PREVENT BAND SAW OPERATION WHEN BLADE IS NOT UNDER FULL TENSION

(71) Applicant: Barry M. Schwaiger, Murfreesboro, TN (US)

(72) Inventor: Barry M. Schwaiger, Murfreesboro, TN (US)

(73) Assignee: WALTER MEIER (MANUFACTURING) INC., La Vergne, TN (US)

(21) Appl. No.: 13/964,281

(22) Filed: Aug. 12, 2013

Related U.S. Application Data
(60) Provisional application No. 61/684,198, filed on Aug. 17, 2012.

(51) Int. Cl. B23D 55/10; B26D 7/24

(52) U.S. Cl. CPC B23D 55/10; B26D 7/24
USPC 83/13; 83/399

(57) ABSTRACT

A band saw has a blade tension adjustment to permit the blade tension to be reduced during times when the saw will not be used for a time. A sensor is connected to the blade tension adjustment. The sensor inhibits saw operation if the tension adjustment is set to a reduced tension setting. The sensor enables the saw operation if the tension adjustment is set to a full operating tension setting.

### CROSS-REFERENCE TO RELATED APPLICATION

The present application claims the benefit of U.S. Provisional Patent Application Ser. No. 61/684,198, filed Aug. 17, 2012, which is incorporated herein by reference.

### BACKGROUND OF THE INVENTION

1. Field of the Invention

The present invention relates generally to a power tool and more particularly to a system and method to prevent operation of a band saw when the blade tension control has been set to a tension state that is less than full tension.

2. Description of the Related Art

A band saw is a power tool that includes a blade in the shape of a continuous loop that is typically formed of steel and provided with saw teeth along one edge. The loop or band of the band saw blade rides on two wheels that are mounted in the same plane. A drive motor is connected to rotate one of the wheels, causing the blade to move at relatively high speed. Cutting is performed by pressing a workpiece against the portion of the blade that extends between the two wheels.

The blade is kept under tension during use of the saw. If the saw is not being used for some time, the blade can deform and cause vibration during use of the saw. The wheels of the band saw are commonly coated with rubber on their rims to reduce noise and slippage of the blade. The rubber coating on the wheels can deform is the blade is kept under tension during periods between usage of the band saw.

Users of band saws, particularly infrequent users of the band saws, such as home hobbyists, are advised to release the tension from the saw blade if the saw will not be used for a time. The user must reapply tension to the blade prior to use to ensure that the blade does not slip from the wheels or otherwise cause an unsafe condition. The user must remember to tension the blade if the full tension has been released.

U.S. Pat. No. 6,739,231 B2 discloses a quick release lever for a band saw that permits a user to release tension from the band saw blade or to reapply tension to the blade by movement of a lever. The user must remember to move the lever to the full tension position prior to use of the band saw.

### SUMMARY OF THE INVENTION

The present invention provides a system and method by which a band saw is prevented from operating or starting when the tension apparatus has been set to a partial or full tension release. A sensor in the band saw detects the position of the tension release mechanism and if the tension release is not in the full tension position, the sensor prevents the user from operating the saw.

### BRIEF DESCRIPTION OF THE DRAWINGS

FIG. 1 is an example of a band saw;

FIG. 2 is a view of a different band saw showing the upper and lower housings open to reveal the wheels on which the blade rides;

FIG. 3 is an enlarged side view of an upper housing of a band saw showing a quick release tension lever; and

FIG. 4 is an enlarged side view of an upper wheel of the band saw including a switch that senses a position of the quick release lever.

### DETAILED DESCRIPTION OF THE PREFERRED EMBODIMENTS

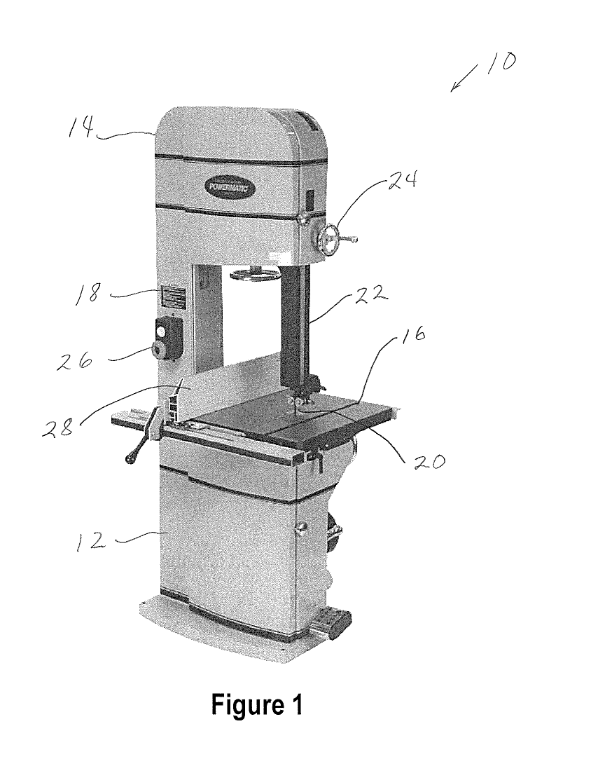

FIG. 1 shows a band saw 10 for cutting workpieces, such as wood or metal. The band saw 10 includes a lower housing 12 containing a motor and a lower wheel, an upper housing 14 containing an upper wheel, a work table 16 mounted on the lower housing 12 on which the workpieces are supported during cutting. The upper housing 14 is connected to the lower housing 12 by a vertical housing portion 18, through which a rear portion of the blade 20 passes as it extends between the wheels. A blade guard 22 is in place over the front portion of the blade 20. The blade guide 22 ends just above the top of the work table 16 to reveal a portion of the blade path that is exposed for cutting. A wheel 24 for raising and lowering the blade guard 22 is provided. A power switch 26 to turn on the saw 10 is provided at the vertical portion 18. The table 16 is provided with an adjustable work piece guide 28. Other adjustments and controls are provided as known.

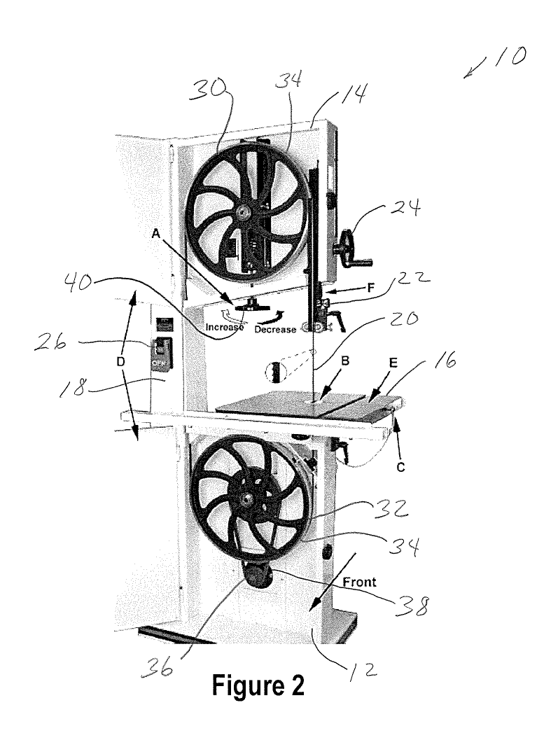

FIG. 2 shows the upper and lower housings 14 and 12 open to reveal the upper and lower wheels 30 and 32 that the band blade 20 rides on. The upper and lower wheels 30 and 32 are provided with a shaped rim, preferably provided with a rubber blade contact element 34 on the rim of each wheel. The wheels 30 and 32 with their rubber rims 34 are sometimes referred to as tires. The lower wheel 32 is driven by a motor 36 that is connected to the lower wheel by a belt and pulley arrangement 38. The blade guard 22 is in the raised position to reveal a length of the blade 20 between the end of the blade guard 22 and the work table 16. In this band saw, a blade tension adjustment control 40 is provided on the underside of the upper housing 14.

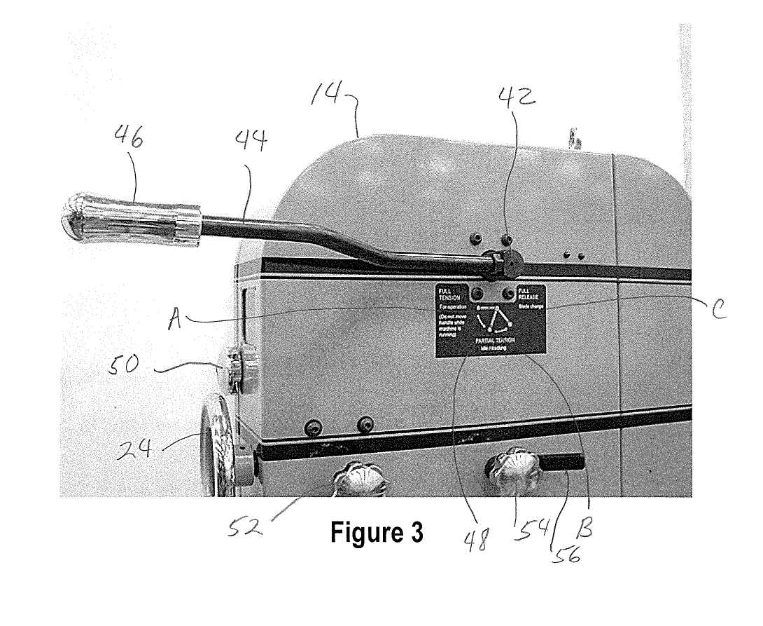

FIG. 3 shows a portion of the upper housing 14 of the band saw 10 from the opposite side of that shown in FIG. 1. Extending from the housing 14 is a rotatable control 42 that is connected to an elongated lever 44. The lever 44 has a hand grip 46 at its free end. The lever 44 can be moved to three different positions in this illustrated embodiment. The first position A, as shown, with the lever 44 in a substantially horizontal position is a position that provides full tension on the band saw blade 20. In the full tension position A, the saw 10 is ready for use. A second position B is indicated by a sign 48 or other indicator on the housing 14. The second position B for the illustrated lever 44 is a position extending downward yet still to the front of the band saw. The second position B provides a partial release of the tension on the band saw blade 20, such as by moving the upper wheel 30 toward the lower wheel 32 by a distance sufficient to relieve tension on the blade 20 and reduce deforming of the rubber rim 34 on the wheel. By moving the lever 44 to the second position B between uses of the band saw 10, particularly if the band saw 10 will not be used for an extended time, the blade 20 and the rubber rim 34 on the wheels 30 and 32 are not subject to being deformed. Vibration and other operational issues are reduced.

A third position C is indicated by the sign 48 on the housing 14. The third position C is a full release position at which the tension on the blade 20 is release sufficiently that the blade 20 can be removed and a different blade installed on the band saw device 10. The wheels 30 and 32 are moved toward one another sufficiently to place the blade 20 in a full slack state. The partial tension position B is between the full tension position A and the full release position C of the tension lever 44.

The band saw 10 shown in FIG. 3 is a 15 inch band saw, in other words a saw using 15 inch diameter wheels 30 and 32. The present invention is not limited to the size of the band saw with which it is used, and other sizes of band saw are within the scope of this invention. Also visible in the view of FIG. 3 is a front access door latch 50, visible at the far left in the figure above the hand wheel 24 on the front of the housing 14. The hand wheel 24 at the left of the figure, also on the front of the housing 14, is operated to raise and lower the blade guide and the associated blade guard 22. On the side of the housing 14 is a knob 52, to the left in the view of the figure, that locks the guide post for the blade 20. To the right in the figure is a knob 54 that provides blade tracking adjustment, and next to the tracking adjustment knob 54 is a lever 56 that locks the desired tracking adjustment in place.

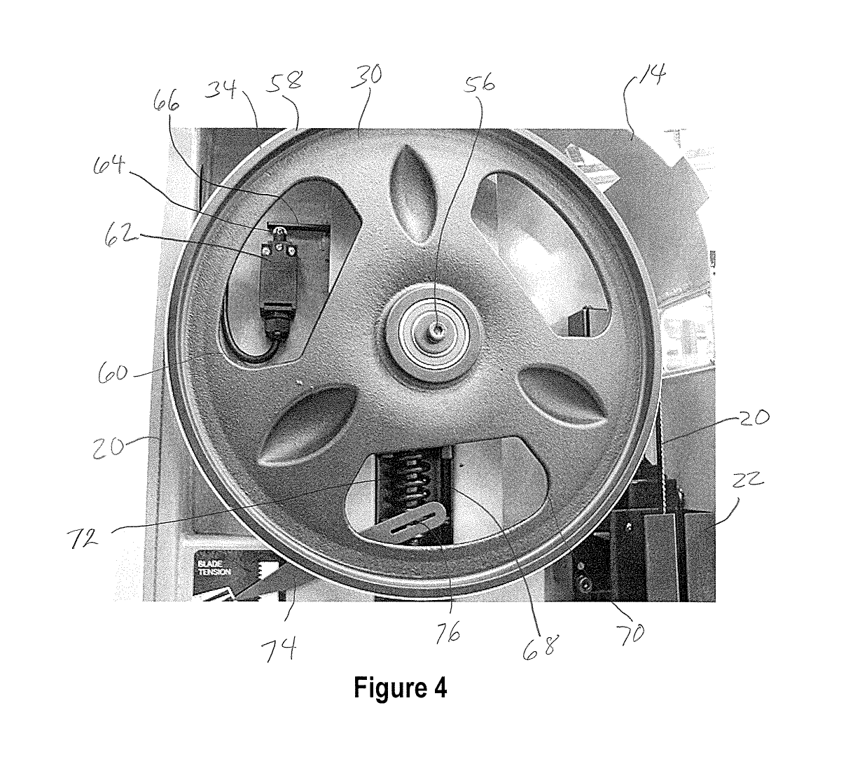

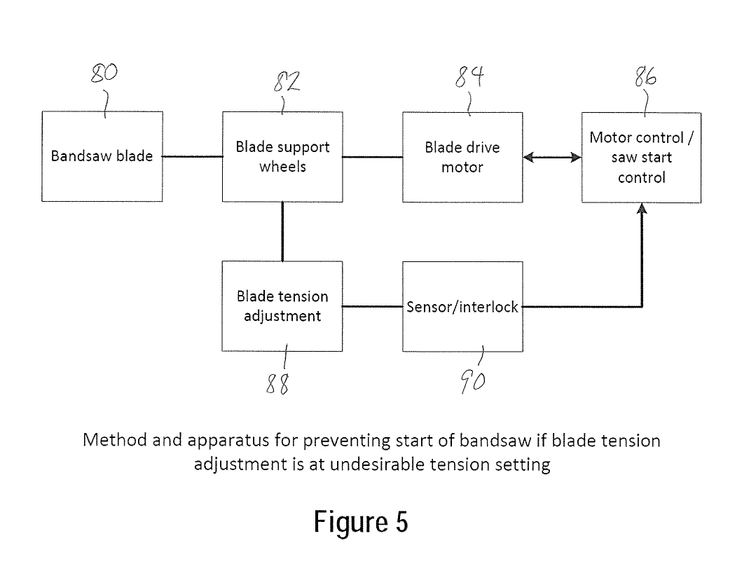

Turning to FIG. 4, the upper housing 14 of the band saw 10 has been opened by opening the side opposite the side with the tension lever 44. Within the upper housing 14 is the upper wheel 30 on which rides the band saw blade 20. The wheel 30 includes a central axel 56 about which the wheel 30 rotates, and includes a rim 58 that is covered by a rubber covering 34 that is in contact with the blade 20. The blade 20 can be seen extended from each side of the wheel 30 toward the lower wheel. Through an opening 60 in the wheel 30 is visible a micro-switch 62, which is mounted on an interior wall of the upper housing.

The micro-switch 62 is connected electrically to a coil circuit in the magnetic starter for the motor 36 of the band saw device 10. If the micro-switch 62 is in an operated or closed position, the micro-switch 62 closes a circuit to provide electrical power to the coil to hold the line contacts for the motor 36, enabling the motor 36 of the band saw 10 to start and enabling the motor 36 to continue operating. If the micro-switch 62 is in its non-operated or open position, power is not provided to the coil and a spring inside the coil opens contacts so that power to the motor 36 is interrupted. This interruption in the circuit prevents the motor 36 from starting. If the motor 36 is already running, the movement of the micro-switch 62 to the non-operated position interrupts power to the motor 36 to stop the motor and hence band saw. The micro-switch 62 is connected to the magnetic starter of the band saw and basically adds an interruptible circuit to the magnetic starter coil.

The micro-switch 62 has a roller 64 at the top of the switch unit that is displacable between extended and non-extended positions. Movement of the roller 64 opens or closes the circuit in which the micro-switch 62 is connected. The roller 64 is in contact with an arm 66 that is connected to the tension adjustment lever 44 shown in FIG. 3. As the lever 44 is moved between the full tension position A, the partial tension position B, and the full release position C, the arm 66 inside the housing 14 moves. The arm 66 and micro-switch 62 are positioned so that the motor 36 of the band saw device can only be operated when the tension on the blade 20 is sufficient for safe operation. The switch element of the illustrated micro-switch 62 is biased to the open position by an internal spring. In this example, moving the tension lever 44 to the second position B, where tension is partially released from the blade 20, moves the arm 66 within the housing 14 away from the body of the micro-switch 62, allowing the switch element to move by spring force to an open contact position. The motor 36 cannot be started when the tension lever 44 is in the second position B.

The motor 36 also cannot be started when the tension lever 44 is in the full release position C. In the preferred embodiment, the tension lever 44 must be at the full tension position A, or at least sufficiently close to the full tension position A that a safe operating position of the saw is possible.

The micro-switch 62 is thereby positioned to detect the position of the tension lever 44, either directly or indirectly. Other means of sensing the position of the tension lever 44 are possible within the scope of this invention.

In a preferred embodiment, the arm 66 is always in contact with the roller 64 of the micro-switch 62. For example, a mechanism may link the arm 66 to the tension lever 44 to enable the large angle movements of the tension lever 44 to be translated into small angle movements of the arm 66 or into linear or near linear movements, as tension is applied and released.

Other means to interrupt power to the motor or to the starter or to otherwise prevent operation of the band saw when the tension lever is at a position other than full tension are possible and are within the scope of this invention.

The user who attempts to start the saw 10 with the tension lever 44 in the wrong position is prevented from starting the saw by the present apparatus. The position of the lever 44 indicates to the user the reason for the saw not starting so that the user need only look to the tension lever to realize that it must be returned to the full tension position to enable saw starting. It is envisioned that an indicator, such as an indicator light or a message on a display panel, may be provided to indicate to the user the reason for the saw not starting.

The apparatus as shown and described herein prevents a user who has moved the tension lever 44 to the full release or the partial release position, for example to prevent distortion of the blade and wheels between uses, from operating the saw until full tension is applied to the blade. A potentially dangerous condition is thereby avoided.

FIG. 4 also shows a tension spring 68 which applies tension to the blade 20 by applying a spring force to the upper wheel 30. The tension spring 68 is visible through the lower opening 70 in the wheel 30 in this view. The tension spring 68 is mounted on a spring shaft 72 that is part of the tension adjustment system. Also visible in this view is a tension indicator pointer 74. The pointer 74 has a slot in which rides a pin 76 that extends from the spring and spring shaft 72. The pointer 74 is pivotally mounted within the housing 14. The opposite end of the pointer points to a gauge that indicates the correct tension for various conditions, blade types, etc.

The blade guide and blade shield 22 are visible at the lower right in the image.

FIG. 5 shows a functional block diagram of another embodiment of the present apparatus. A band saw blade 80 is mounted on blade support wheels 82 so that the blade 80 moves as the wheels 82 rotate. A blade drive motor 84 is connected to drive at least one of the wheels 82 which in turn moves the blade 80 so that a work piece is cut by the blade 80. The motor operation 84 is controlled by a motor control device 86 which controls whether the motor 84 operates or not. The motor control device 86 may be a saw start control. The user operates the start control or motor control 86 to start the saw operation.

The blade support wheels 82 are connected to a blade tension adjustment 88. Any blade tension adjustment apparatus may be provided, including the tension adjustment lever or some other tension adjustment device. The tension adjustment device 88 is sensed by a sensor 90 to determine if the blade tension is at full operating tension or if the tension has been released to a lesser tension level. The sensor 90 may instead sense the position of the blade support wheels 82 or may even sense the blade 80 directly, in alternative embodiments. The sensor 90 may be replaced by an interlock that prevents operation of a mechanical or electrical component if the tension is set at the incorrect level. In the present example, the sensor is connected to the motor control or saw start control 86 to prevent the saw from operating when the blade tension is at an improper level.

The sensor 90 can be a position sensor, such as the micro-switch sensor shown in FIG. 4, or can be a quantitative sensor that determines the magnitude of the tension applied to the blade. If the blade tension is determined to be below a desired threshold, the saw operation is inhibited. The tension sensor 90 may also sense excess tension applied to the blade and prevent operation of the saw if the tension exceeds a desired level, or may otherwise indicate excess tension to the user. The sensor 90 may operate to interrupt the electrical circuit from the motor start circuit or from the saw start switch or some other circuit that is required to operate the saw. If an interlock is provided to inhibit saw operation when the tension is set to an incorrect level, the interlock may act to prevent operation of the start switch, to prevent rotation of the motor, to prevent rotation of the wheels, to interrupt transmission of rotational power between the motor and the wheels such as via an interruptable transmission linkage between the motor and wheels, to prevent movement of the blade for example by a blade brake, or through some other system interrupt or operational inhibitor.

The present invention also encompasses a method for preventing operation of a band saw 10 when tension on the blade 20 is set at less than full tension. The steps of the method, which are apparent from a review of this specification, may include sensing a position of a tension release lever 44, and inhibiting operation of the saw when the tension release lever 44 is determined to be at a position other than a full tension position. If the sensing of the tension release lever 44 determines that the lever is at a full tension position, then the operation of the saw is enabled. The user can only cause the saw to operate when the operation of the saw is enabled.

Although other modifications and changes may be suggested by those skilled in the art, it is the intention of the inventors to embody within the patent warranted hereon all changes and modifications as reasonably and properly come within the scope of their contribution to the art.

I claim:

1. A band saw device, comprising:
a housing including an upper housing portion and a lower housing portion;
a work table;
an upper wheel mounted for rotation in the upper housing portion and a lower wheel mounted for rotation in the lower housing portion;
a drive motor connected to drive at least one of the upper and lower wheels;
a motor circuit connected to the motor to operate the motor;
a band saw blade riding on the upper and lower wheels and passing through the work table;
a tension release lever connected to at least one of the upper and lower wheels to permit user adjustment of tension on the blade by adjusting relative spacing of the upper and lower wheels from one another, the tension release lever being movable by a user between a full tension position and a tension release position; and
a sensor mounted to sense a position of the tension release lever, the sensor being connected to the motor circuit to inhibit motor operation of the motor when the sensor determines that the tension release lever is at the tension release position, the sensor enabling operation of the motor circuit and motor when the sensor determines that the tension release lever is at the full tension position.

2. A band saw device as claimed in claim 1, wherein the sensor is a micro-switch having an actuator in contact with one of the tension release lever and an extension of the tension release lever.

3. A band saw device as claimed in claim 1, wherein the sensor is mounted within the upper portion of the housing.

4. A band saw device as claimed in claim 1, wherein the tension release lever is moveable between a full tension position, a partial tension position, and a full release position;
the sensor being operable to inhibit saw operation when the tension release lever is at the partial tension position and when the tension release lever is at the full release position.

5. A band saw device as claimed in claim 4, wherein the sensor includes an actuator in contact with an extension of the tension release lever in all of the full tension position, the partial tension position, and the full release position.

6. A band saw operation inhibitor, comprising:
a sensor mounted in a band saw device to sense at least one of a full tension condition of a band saw blade and a tension release position of the band saw blade; and
a saw operation inhibitor connected to the sensor to inhibit operation of the band saw device when the sensor senses a less than full tension condition of the band saw blade.

7. A band saw operation inhibitor as claimed in claim 6, wherein the sensor is mounted to sense a position of a tension release lever of the band saw device.

8. A band saw operation inhibitor as claimed in claim 7, wherein the sensor is a micro-switch sensor having an actuator with a roller wheel disposed at an end of the actuator, the roller wheel being in contact with one of the tension release lever and an extension of the tension release lever in a sensing position.

9. A band saw operation inhibitor as claimed in claim 6, wherein the saw operation inhibitor includes an interruptable connection in a motor start circuit of the band saw device.

10. A band saw operation inhibitor as claimed in claim 6, wherein the saw operation inhibitor includes an interlock operable to inhibit saw operation when the sensor senses a less than full tension condition of the band saw blade.

11. A band saw operation inhibitor as claimed in claim 6, wherein the sensor is mounted and operates to sense tension on the band saw blade.

12. A method for operating a band saw, comprising:
permitting user adjustment of tension on a band saw blade between a full tension and a partial tension condition;
sensing the tension applied to the band saw blade to determine whether the tension is at full tension or partial tension; and
inhibiting operation of the band saw if the tension is determined to be at partial tension, otherwise enabling operation of the band saw if the tension is determined to be at full tension.

13. A method as claimed in claim 12, further comprising:
sensing the tension applied to the band saw blade to determine whether the blade is at a full tension release condition; and
inhibiting operation of the band saw if the tension is determined to be at the full tension release condition.

14. A method as claimed in claim 12, wherein the inhibiting step includes disabling a motor operation circuit of a band saw device.

15. A method as claimed in claim 12, wherein the sensing step includes sensing a position of a user adjusted tension control device.

16. A method as claimed in claim 12, wherein the user adjustment of tension is permitted by movement of a tension lever between at least two positions, and
wherein the sensing of the tension is by sensing the position of the tension lever either directly or indirectly.

17. A method as claimed in claim 16, wherein the tension lever is adjustable by a user between a full tension position and a partial tension position and a full release position; and
wherein the sensing of the tension senses the partial tension position and the full release tension for inhibiting saw operation, the sensing of the tension sensing the full tension position to permit saw operation.

18. A band saw device, comprising:
a housing having an upper portion and a lower portion;
upper and lower wheels in the respective upper and lower portions of the housing;
a band saw blade extending about the upper and lower wheels;
a motor operable to drive at least one of the upper and lower wheels;
a tension adjustment operable to adjust tension on the band saw blade between a full tension position and a full release position and a partial tension position, the tension adjustment operating to move at least one of the upper and lower wheels relative to the other of the upper and lower wheels;
a sensor mounted in the housing to sense a position of the tension adjustment to determine if the band saw blade is at full tension; and
a band saw operation inhibitor connected to the sensor to inhibit operation of the band saw if the sensor fails to sense that the band saw blade is at full tension.

19. A band saw device as claimed in claim 18, wherein the band saw operation inhibitor includes a connection in a motor start circuit of the motor to inhibit operation if the sensor fails to sense that the band saw blade is at full tension.

20. A band saw device as claimed in claim 18, wherein the sensor senses the position of the tension adjustment at all of the full tension position and the full release position and the partial tension position.
